(19) United States
(12) Patent Application Publication
(10) Pub. No.: US 2015/0116707 A1
(43) Pub. Date: Apr. 30, 2015

(54) SPECTROSCOPIC MEASUREMENT DEVICE AND SPECTROSCOPIC MEASUREMENT METHOD

(71) Applicant: Seiko Epson Corporation, Tokyo (JP)

(72) Inventor: Tetsuo TATSUDA, Ina (JP)

(21) Appl. No.: 14/525,719

(22) Filed: Oct. 28, 2014

(30) Foreign Application Priority Data
Oct. 29, 2013 (JP) 2013-223980

(51) Int. Cl. G01J 3/32; G01J 3/26

(52) U.S. Cl. CPC G01J 3/32; G01J 3/26
USPC 356/326

(57) ABSTRACT

A spectroscopic measurement device includes a variable wavelength interference filter capable of selectively emitting light with a predetermined wavelength out of incident light, and changing the wavelength of the light to be emitted, a light receiving element adapted to output a detection signal corresponding to a light exposure in response to an exposure to the light emitted from the variable wavelength interference filter, a detection signal acquisition section adapted to obtain a plurality of detection signals different in the light exposure from each other with respect to each of the wavelengths, and a selection section adapted to select the detection signal having a highest signal level out of signal levels of the detection signals obtained, which are lower than a maximum signal level corresponding to a saturated light exposure of the light receiving element.

### BACKGROUND

1. Technical Field

The present invention relates to a spectroscopic measurement device and a spectroscopic measurement method.

2. Related Art

In the past, there has been known a measurement device for receiving light having been transmitted through an optical element to measure the intensity of the light received (see, e.g., JP-A-2007-127657 (Document 1)).

In Document 1, there is described an imaging device for receiving the measurement light having been transmitted through a plurality of bandpass filters having respective bands different from each other using an imaging element as an optical element, and thus obtaining the reflection dispersion spectrum (dispersion spectrum) of an object.

In the imaging device described in Document 1, after setting the measurement object, in order to set an exposure time for obtaining the light exposure in a correct exposure range of the imaging element, preliminary exposure is performed on the measurement object for each of the bandpass filters. Then, based on the result of the preliminary exposure, the exposure time is obtained for each of the wavelengths corresponding respectively to the bandpass filters. Then, when measuring the dispersion spectrum of the measurement object, imaging of the measurement object is performed with the exposure time corresponding to each of the wavelengths.

However, in the imaging device described in Document 1, there is a problem that if the measurement object is changed, it is necessary to perform the preliminary exposure again in order to set the exposure time in each of the measurement wavelengths to the new measurement object, and it takes much time for the measurement.

### SUMMARY

An advantage of some aspects of the invention is to provide a spectroscopic measurement device and a spectroscopic measurement method capable of achieving reduction of the measurement time even in the case of performing the spectroscopic measurement on an arbitrary measurement object.

A spectroscopic measurement device according to an aspect of the invention includes a spectroscopic element capable of selectively emitting light with a predetermined wavelength out of incident light, and changing the wavelength of the light to be emitted, a light receiving element adapted to output a detection signal corresponding to alight exposure in response to an exposure to the light emitted from the spectroscopic element, a detection signal acquisition section adapted to obtain a plurality of detection signals different in the light exposure from each other with respect to each of the wavelengths, and a selection section adapted to select the detection signal having a highest signal level out of signal levels of the detection signals obtained, which are lower than a maximum signal level corresponding to a saturated light exposure of the light receiving element.

In this aspect of the invention, the detection signals from the light receiving element are obtained with a plurality of light exposures different from each other with respect to each of the wavelengths. Then, there is selected the detection signal having the highest signal level out of the plurality of detection signals obtained with respect to each of the wavelengths and having the signal level not exceeding the highest signal level.

According to this process, it is possible to select the detection signal corresponding to the maximum light exposure not exceeding the saturated light exposure with respect to the plurality of wavelengths, and thus, suppression of overexposure and reduction of noise can be achieved.

Further, it is not necessary to perform the preliminary exposure for setting the correct exposure time for each of the wavelengths in each of the measurement objects in order to obtain the light exposure not exceeding the saturated light exposure and within the correct exposure range with respect to the plurality of wavelengths. Therefore, the measurement time can be shortened. The correct exposure range described here corresponds to the range of the light exposure with which the grayscale variation can correctly be measured without causing overexposure or underexposure in the light exposure.

Further, since it is not necessary to perform the preliminary exposure, the measurement time can further be shortened in the case of continuously performing the measurement while changing the measurement object.

In the spectroscopic measurement device according to the aspect of the invention described above, it is preferable that the detection signal corresponding to a minimum light exposure out of the plurality of detection signals is obtained in an exposure condition in which when making the light reflected by a high-reflectance reference object having a reflectance higher than a first specified value with respect to light with each of wavelengths in a predetermined wavelength band enter the spectroscopic element, and then receiving the light with the light receiving element while sequentially changing the wavelength with the spectroscopic element, the detection signal corresponding to each of the wavelengths has a signal level lower than the maximum signal level.

According to the configuration described above, the exposure condition (e.g., the exposure time and the light receiving sensitivity in the light receiving element) is set so that the level of each of the detection signals does not exceed the maximum signal level in the case of obtaining the detection signal for each of the wavelengths with respect to the high-reflectance reference object (e.g., a white reference object in the case of the visible light range).

In this case, the overexposure does not occur with respect to each of the wavelengths in the predetermined wavelength band to be the measurement target. Therefore, in the case of obtaining the plurality of detection signals different in light exposure from each other with respect to each of the wavelengths, it is possible to obtain at least one detection signal corresponding to the light exposure lower than the upper limit value (the saturated light exposure) of the correct exposure range, namely the detection signal with a level lower than the maximum signal level.

In the spectroscopic measurement device according to the aspect of the invention described above, it is preferable that the detection signal corresponding to the minimum light exposure out of the plurality of detection signals is obtained in an exposure condition in which when making the light reflected by the high-reflectance reference object enter the spectroscopic element, and then receiving the light with the light receiving element while sequentially changing the wavelength with the spectroscopic element, a maximum value of the detection signal corresponding to each of the wavelengths is lower than the maximum signal level, and is within a first threshold value from the maximum signal level.

In the configuration described above, the exposure condition in the case of measuring the light reflected by the high-reflectance reference object is set to the exposure condition for setting the maximum value of the light exposure to be lower than the saturated light exposure and approximate to the saturated light exposure. Thus, it is possible to set the signal level of the detection signal (the maximum value of the detection value), which corresponds to the maximum light intensity of the light to be made to be received by the light receiving element, to a value approximate to the maximum signal level. Therefore, it is possible to increase the width of the detection value from the maximum value to the lower limit signal level corresponding to the lower limit value of the light exposure of the correct exposure, and thus, the range of the signal level, which can be detected by the light receiving element, can effectively be used.

In the spectroscopic measurement device according to the aspect of the invention described above, it is preferable that the detection signal corresponding to a maximum light exposure out of the plurality of detection signals is obtained in an exposure condition in which when making the light reflected by a low-reflectance reference object having a reflectance lower than a second specified value smaller than the first specified value with respect to light with each of the wavelengths in the predetermined wavelength band enter the spectroscopic element, and then receiving the light with the light receiving element while sequentially changing the wavelength with the spectroscopic element, a signal level of the detection signal is one of equal to and higher than a lower limit signal level corresponding to a lower limit value of the light exposure of correct exposure.

According to the configuration described above, the exposure condition (e.g., the exposure time and the light receiving sensitivity in the light receiving element) is set so that the minimum signal level of each of the detection signals does not become lower than the lower limit signal level in the case of obtaining the detection signal for each of the wavelengths with respect to the low-reflectance reference object (e.g., a black reference object in the case of the visible light range).

In the configuration described above, in the detection signal corresponding to the minimum light exposure, since the exposure condition is set based on the high-reflectance reference object, in the case in which, for example, a measurement object low in reflectance at a predetermined wavelength is targeted, a sufficient light exposure cannot be obtained at that wavelength, and the S/N ratio becomes worse. In this case, although it results that the detection signal having a higher signal level is selected, in the case in which the detection signal does not have a signal level based on the correct exposure range (in the case in which the signal level is equal to or higher than the maximum signal level or lower than the lower limit signal level), it becomes difficult to obtain a detection signal high in accuracy. In contrast, in the configuration described above, the exposure condition is set so that the signal level of the detection signal becomes equal to or higher than the lower limit signal level even with respect to the measurement object low in reflectance.

Therefore, when the detection signal having the maximum signal level is obtained by the selection section, there can be obtained a signal high in accuracy with contamination of the detection signal with a noise component suppressed.

In the spectroscopic measurement device according to the aspect of the invention described above, it is preferable that the detection signal corresponding to the maximum light exposure out of the plurality of detection signals is obtained in an exposure condition in which when making the light reflected by the low-reflectance reference object enter the spectroscopic element, and then receiving the light with the light receiving element while sequentially changing the wavelength with the spectroscopic element, a minimum value of the detection signal corresponding to each of the wavelengths is higher than the lower limit signal level, and is within a second threshold value from the lower limit signal level.

In the configuration described above, the exposure condition in the case of measuring the light reflected by the low-reflectance reference object is set to the exposure condition for setting the minimum value of the light exposure to value larger than and approximate to the lower limit value of the correct exposure range. Thus, it is possible to set the signal level of the detection signal (the minimum value of the detection value), which corresponds to the minimum light intensity of the light to be made to be received by the light receiving element, to a value approximate to the lower limit signal level. Therefore, it is possible to increase the width of the detection value from the minimum value to the maximum signal level in the exposure condition described above, and thus, the range of the signal level, which can be detected by the light receiving element, can effectively be used.

In the spectroscopic measurement device according to the aspect of the invention described above, it is preferable that the light receiving element has a plurality of pixels adapted to receive light, and the selection section selects the detection signal with respect to each of the pixels.

According to the configuration described above, the spectroscopic measurement device receives the light with each of the wavelengths using the light receiving element having the plurality of pixels to obtain the detection signals corresponding to a plurality of light exposures different from each other for each of the pixels. Further, the detection signal having the highest signal level within the maximum signal level is selected for each of the pixels.

In the case of receiving the light with the light receiving element having a plurality of pixels to obtain, for example, a spectral image, the signal level becomes high in the pixel corresponding to a region high in reflectance with respect to a predetermined wavelength, and the signal level becomes low in the pixel corresponding to a region low in reflectance in the image. In such a case, if the exposure time is set so that the light exposure corresponding to the region high in reflectance does not exceed the saturated light exposure in the case of setting the exposure time corresponding to each of the wavelengths using, for example, the preliminary exposure, it is not achievable to obtain a sufficient light exposure in the pixel corresponding to the region low in reflectance. Therefore, in the pixel corresponding to the region low in reflectance, the difference between the light exposure and the noise component is small, and the content of the noise component in the detection signal becomes high to prevent acquisition of the spectral image high in accuracy.

In contrast, if the exposure time sufficient to obtain the light exposure in the region low in reflectance within the correct exposure range is set, there is a possibility that the overexposure occurs in the pixel corresponding to the region high in reflectance, and it is not achievable to obtain the spectral image high in accuracy.

In contrast, in the configuration described above, since the detection signal is selected pixel by pixel as described above, even in the pixel corresponding to the region low in reflectance, the measurement with the noise component reduced (high in S/N ratio) can be performed. Further, as described above, since the detection signal not exceeding the maximum signal level is selected pixel by pixel, generation of the pixel, in which the correct received light intensity cannot be obtained due to overexposure, can be suppressed. According to the above, the spectroscopic measurement high in accuracy can be performed.

In the spectroscopic measurement device according to the aspect of the invention described above, it is preferable that the detection signal acquisition section controls an exposure time of the light receiving element to obtain a plurality of detection signals different in light exposure.

According to the configuration described above, it is possible to set the exposure time as the exposure condition to make the light exposures different from each other due to the difference in exposure time. Therefore, it is not necessary to, for example, use a plurality of light receiving elements different in the area of the light receiving surface in the light receiving element, and simplification of the configuration can be achieved.

In the spectroscopic measurement device according to the aspect of the invention described above, it is preferable that the light receiving element sequentially reads out a charge obtained by the exposure with an exposure time shorter than a maximum exposure time for maximizing the light exposure using a nondestructive readout method not accompanied by reset of the accumulated charge.

According to the configuration described above, when performing the exposure with a plurality of exposure times, the light exposures corresponding respectively to the exposure times are sequentially read out in the plurality of exposure times within the maximum exposure time. In other words, the charge accumulated for each of the exposure times is not reset, and the detection signals corresponding respectively to the plurality of exposure times (the light exposures) can be obtained in a single measurement (the measurement until the maximum exposure time), and thus, the measurement time can be shortened.

In the spectroscopic measurement device according to the aspect of the invention described above, it is preferable that the light receiving element has a plurality of light receiving regions different in sensitivity from each other.

According to the configuration described above, the spectroscopic measurement device receives the light from the measurement object with the light receiving element having a plurality of light receiving regions different in sensitivity from each other, and then obtains the light exposure corresponding to each of the light receiving regions. In other words, defining the exposure condition as the sensitivity of the light receiving element, the detection signals corresponding respectively to the light exposures different from each other are obtained. Thus, even in the case of making the light to be received with the same exposure time with respect to each of the light receiving regions, a plurality of light exposures different from each other and corresponding respectively to the sensitivities of the light receiving regions can be obtained at the same time, and thus, the measurement time can be shortened.

In the spectroscopic measurement device according to the aspect of the invention described above, it is preferable that the spectroscopic element is a Fabry-Perot filter.

According to the configuration described above, by using the Fabry-Perot filter as the spectroscopic element, it is possible to measure the measurement target wavelength at fine intervals of, for example, 10 nm. Therefore, compared to the case in which the controllable intervals of the measurement target wavelength are long, the measurement can be performed on the measurement target wavelength band at a lot of measurement wavelengths (e.g., several tens of measurement wavelengths). In this case, if the preliminary exposure described above is performed on the measurement object at a plurality of measurement wavelengths, or the preliminary exposure is performed every time the measurement object is changed, the time consumed by the preliminary exposure is elongated compared to the case of performing the measurement at several wavelengths. Therefore, in the configuration in which it is not necessary to perform the preliminary exposure as in the configuration described above, further reduction of the measurement time can be achieved in the case of using the Fabry-Perot filter.

A spectroscopic measurement method according to another aspect of the invention is a spectroscopic measurement method in the spectroscopic measurement device including a spectroscopic element capable of selectively emitting light with a predetermined wavelength out of incident light, and changing the wavelength of the light to be emitted, a light receiving element adapted to output a detection signal corresponding to a light exposure in response to an exposure to the light emitted from the spectroscopic element, and a processing section adapted to obtain and then process the detection signal, the method including: obtaining a plurality of detection signals different in the light exposure from each other with respect to each of the wavelengths; and selecting the detection signal having a highest signal level out of signal levels of the detection signals obtained, which are lower than a maximum signal level corresponding to a saturated light exposure of the light receiving element.

In this aspect of the invention, similarly to the aspect of the invention related to the spectroscopic measurement device described above, there is selected the detection signal having the highest signal level out of the detection signals corresponding to a plurality of light exposures obtained with respect to each of the wavelengths and having the signal level not exceeding the highest signal level.

Further, as described above, since it is not necessary to perform the preliminary exposure with respect to each of the wavelengths for each of the measurement objects, the measurement time can be shortened. Further, since it is not necessary to perform the preliminary exposure, the measurement time can further be shortened in the case of continuously performing the measurement while changing the measurement object.

### BRIEF DESCRIPTION OF THE DRAWINGS

The invention will be described with reference to the accompanying drawings, wherein like numbers reference like elements.

FIG. 1 is a block diagram showing a schematic configuration of a spectroscopic measurement device according to a first embodiment of the invention.

FIG. 2 is a plan view showing a schematic configuration of a variable wavelength interference filter according to the embodiment.

FIG. 3 is a cross-sectional view showing a schematic configuration of a variable wavelength interference filter according to the embodiment.

FIG. 4 is a graph showing an example of a relationship between the exposure time and the detection signal.

FIGS. 5A and 5B are graphs showing an example of a relationship between a measurement wavelength and a detection signal with respect to a plurality of exposure time values.

FIG. 6 is a flowchart showing a spectroscopic measurement process according to the embodiment.

FIG. 7 is a graph schematically showing a relationship between the exposure time and the detection signal.

FIG. 8 is a block diagram showing a schematic configuration of a spectroscopic measurement device according to a second embodiment of the invention.

FIG. 9 is a diagram schematically showing a configuration of one pixel of a light receiving element according to the embodiment of the invention.

FIGS. 10A and 10B are graphs each schematically showing a relationship between the exposure time and the detection signal.

FIG. 11 is a flowchart showing a spectroscopic measurement process according to the embodiment.

### DESCRIPTION OF EXEMPLARY EMBODIMENTS

### First Embodiment

A first embodiment of the invention will hereinafter be explained with reference to the accompanying drawings.

### Configuration of Spectroscopic Measurement Device

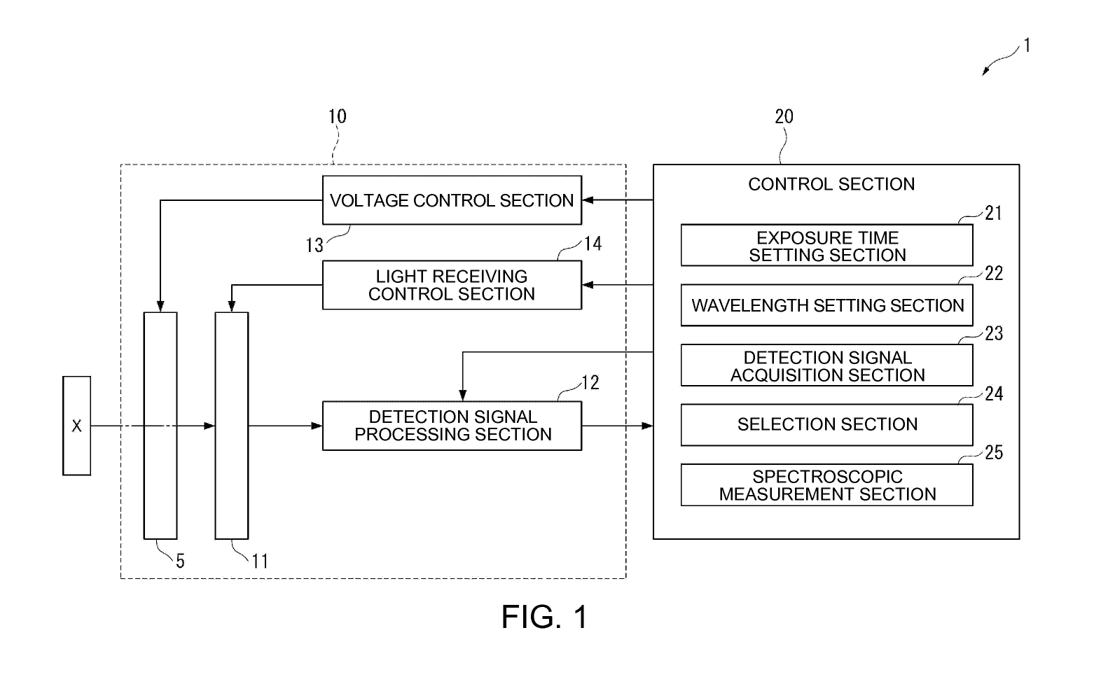

FIG. 1 is a block diagram showing a schematic configuration of a spectroscopic measurement device according to the present embodiment.

The spectroscopic measurement device 1 is a device for analyzing the light intensity of each wavelength in measurement target light having been reflected by a measurement object X to thereby measure the dispersion spectrum of the measurement target light. It should be noted that although in the present embodiment, there is described the example of measuring the measurement target light reflected by the measurement object X, in the case of using a light emitting body such as a liquid crystal panel as the measurement object X, it is possible to use the light emitted from the light emitting body as the measurement target light.

Further, as shown in FIG. 1, the spectroscopic measurement device 1 is provided with an optical module 10, and a control section 20 for controlling the optical module 10, and processing a signal output from the optical module 10.

### Configuration of Optical Module

The optical module 10 is provided with a variable wavelength interference filter 5, a light receiving element 11, a detection signal processing section 12, a voltage control section 13, and a light receiving control section 14.

The optical module 10 guides the measurement target light, which has been reflected by the measurement object X, to the variable wavelength interference filter 5 through an incident optical system (not shown), and then receives the light, which has been transmitted through the variable wavelength interference filter 5, using the light receiving element 11. Then, the detection signal having been output from the light receiving element 11 is output to the control section 20 via the detection signal processing section 12.

### Configuration of Variable Wavelength Interference Filter

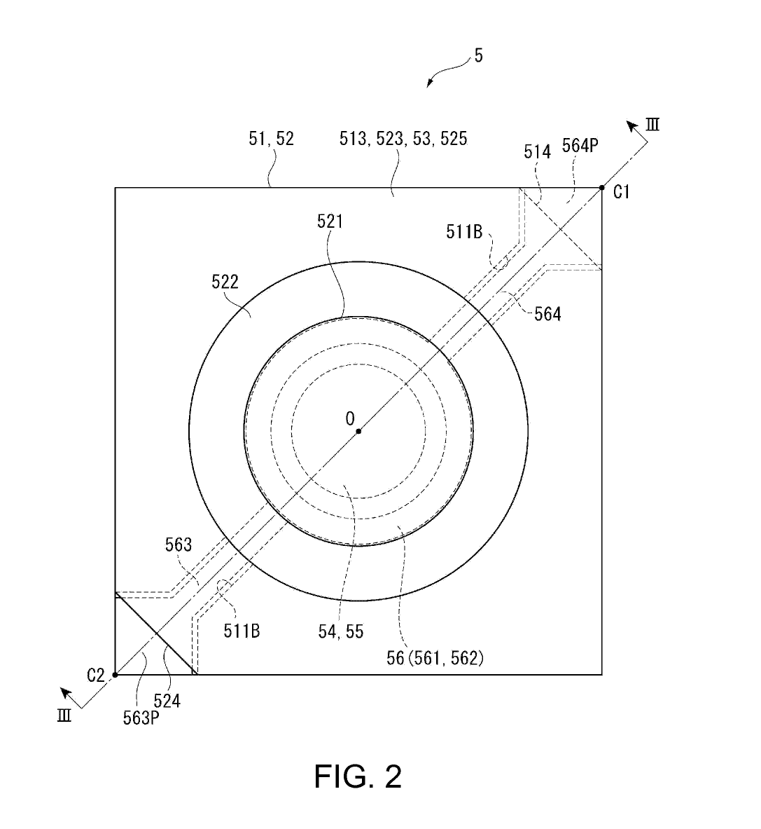

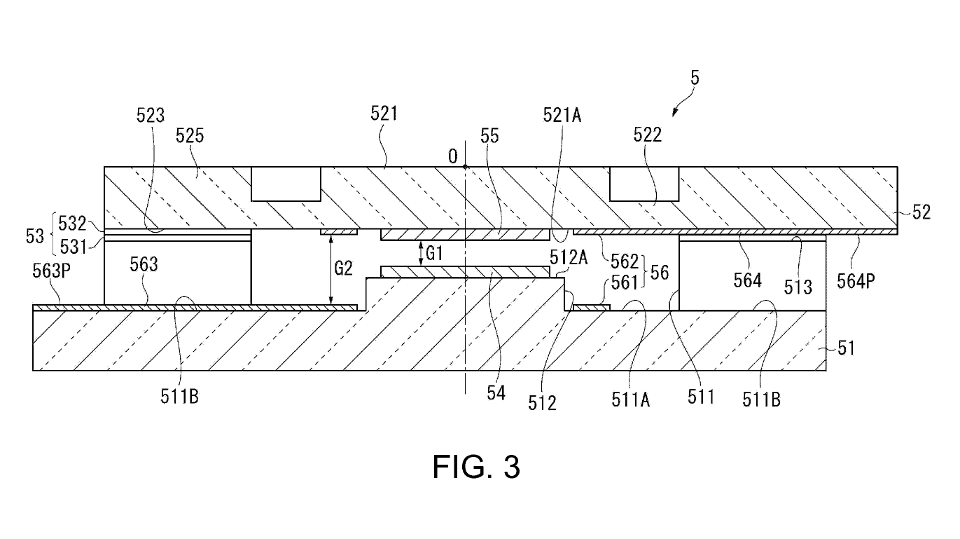

FIG. 2 is a plan view showing a schematic configuration of the variable wavelength interference filter. FIG. 3 is a cross-sectional view of the variable wavelength interference filter in the case of cutting the variable wavelength interference filter along the line shown in FIG. 2.

The variable wavelength interference filter 5 is a variable wavelength Fabry-Perot etalon. The variable wavelength interference filter 5 is provided with a stationary substrate 51, which is an optical member having, for example, a rectangular plate shape, and is formed to have a thickness dimension of, for example, about 500 μm, and a movable substrate 52 formed to have a thickness dimension of, for example, about 200 μm. The stationary substrate 51 and the movable substrate 52 are each made of, for example, a variety of types of glass such as soda glass, crystalline glass, quartz glass, lead glass, potassium glass, borosilicate glass, or alkali-free glass, or a quartz crystal. Further, the stationary substrate 51 and the movable substrate 52 are configured integrally by bonding a first bonding section 513 of the stationary substrate 51 and a second bonding section 523 of the movable substrate 52 to each other with bonding films 53 (a first bonding film 531 and a second bonding film 532) each formed of, for example, a plasma-polymerized film consisting primarily of, for example, siloxane.

The stationary substrate 51 is provided with a stationary reflecting film 54, and the movable substrate 52 is provided with a movable reflecting film 55. The stationary reflecting film 54 and the movable reflecting film 55 are disposed so as to be opposed to each other via a gap G1. Further, the variable wavelength interference filter 5 is provided with an electrostatic actuator 56 used for adjusting (varying) the dimension of the gap G1.

Further, it is assumed that in a filter planar view (hereinafter referred to as a filter planar view) shown in FIG. 2 in which the variable wavelength interference filter 5 is viewed from the thickness direction of the stationary substrate 51 (the movable substrate 52), the planar center point O of the stationary substrate 51 and the movable substrate 52 coincides with the center point of the stationary reflecting film 54 and the movable reflecting film 55, and further coincides with the center point of a movable section 521 described later.

### Configuration of Stationary Substrate

The stationary substrate 51 is provided with an electrode arrangement groove 511 and a reflecting film installation section 512 formed by etching. The stationary substrate 51 is formed to have a thickness dimension larger than that of the movable substrate 52, and no deflection of the stationary substrate 51 occurs due to the electrostatic attractive force generated when applying a voltage between a stationary electrode 561 and a movable electrode 562, or an internal stress of the stationary electrode 561.

Further, a vertex C1 of the stationary substrate 51 is provided with a cutout section 514, and a movable electrode pad 564P described later is exposed on the stationary substrate 51 side of the variable wavelength interference filter 5.

The electrode arrangement groove 511 is formed to have a ring-like shape centered on the planar center point O of the stationary substrate 51 in the filter planar view. The reflecting film installation section 512 is formed so as to protrude toward the movable substrate 52 from the central portion of the electrode arrangement groove 511 in the planar view described above. The bottom surface of the electrode arrangement groove 511 forms an electrode installation surface 511A on which the stationary electrode 561 is disposed. Further, the projection tip surface of the reflecting film installation section 512 forms a reflecting film installation surface 512A.

Further, the stationary substrate 51 is provided with electrode extraction grooves 511B respectively extending from the electrode arrangement groove 511 toward the vertexes C1, C2 of the outer peripheral edge of the stationary substrate 51.

The stationary electrode 561 constituting the electrostatic actuator 56 is disposed on the electrode installation surface 511A of the electrode arrangement groove 511. More specifically, the stationary electrode 561 is disposed in an area of the electrode installation surface 511A, the area being opposed to the movable electrode 562 of the movable section 521 described later. Further, it is also possible to adopt a configuration in which an insulating film for ensuring an insulation property between the stationary electrode 561 and the movable electrode 562 is stacked on the stationary electrode 561.

Further, the stationary substrate 51 is provided with a stationary extraction electrode 563 extending from the outer circumference edge of the stationary electrode 561 toward the vertex C2. The extending tip portion (a part located at the vertex C2 of the stationary substrate 51) of the stationary extraction electrode 563 forms a stationary electrode pad 563P to be connected to the voltage control section 13.

It should be noted that although in the present embodiment, there is shown a configuration of providing the single stationary electrode 561 to the electrode installation surface 511A, it is also possible to adopt, for example, a configuration (a dual electrode configuration) having two concentric electrodes centered on the planar center point O.

As described above, the reflecting film installation section 512 is formed to have a roughly columnar shape coaxial with the electrode arrangement groove 511 and having a diameter smaller than that of the electrode arrangement groove 511, and is provided with the reflecting film installation surface 512A of the reflecting film installation section 512 opposed to the movable substrate 52.

As shown in FIG. 3, the stationary reflecting film 54 is installed in the reflecting film installation section 512. As the stationary reflecting film 54, a metal film made of, for example, Ag, or an alloy film made of, for example, an Ag alloy can be used. Further, it is also possible to use a dielectric multilayer film with a high refractive index layer made of, for example, TiO₂, and a low refractive index layer made of, for example, SiO₂. Further, it is also possible to use a reflecting film obtained by stacking a metal film (or an alloy film) on a dielectric multilayer film, a reflecting film obtained by stacking a dielectric multilayer film on a metal film (or an alloy film), a reflecting film obtained by laminating a single refractive layer (made of, e.g., TiO₂ or SiO₂) and a metal film (or an alloy film) with each other, and so on.

Further, it is also possible to form an antireflection film on a plane of incidence of light (the surface not provided with the stationary reflecting film 54) of the stationary substrate 51 at a position corresponding to the stationary reflecting film 54. The antireflection film can be formed by alternately stacking low refractive index films and high refractive index films, and decreases the reflectance with respect to the visible light on the surface of the stationary substrate 51, while increasing the transmittance thereof.

Further, a part of the surface of the stationary substrate 51, which is opposed to the movable substrate 52, and on which the electrode arrangement groove 511, the reflecting film installation section 512, or the electrode extraction grooves 511B is not formed by etching, constitutes a first bonding section 513. The first bonding section 513 is provided with the first bonding film 531, and by bonding the first bonding film 531 to the second bonding film 532 provided to the movable substrate 52, the stationary substrate 51 and the movable substrate 52 are bonded to each other as described above.

### Configuration of Movable Substrate

The movable substrate 52 is provided with the movable section 521 having a circular shape centered on the planar center point O, a holding section 522 coaxial with the movable section 521 and for holding the movable section 521, and a substrate peripheral section 525 disposed on the outer side of the holding section 522 in the filter planar view shown in FIG. 2.

Further, as shown in FIG. 2, in the movable substrate 52, there is formed a cutout section 524 so as to correspond to the vertex C2, and when viewing the variable wavelength interference filter 5 from the movable substrate 52 side, the stationary electrode pad 563P is exposed.

The movable section 521 is formed to have a thickness dimension larger than that of the holding section 522, and is formed in the present embodiment, for example, to have the same thickness dimension as that of the movable substrate 52. The movable section 521 is formed to have a diameter dimension larger than at least the diameter dimension of the outer circumferential edge of the reflecting film installation surface 512A in the filter planar view. Further, the movable section 521 is provided with a movable electrode 562 and the movable reflecting film 55.

It should be noted that an antireflection film can also be formed on the opposite surface of the movable section 521 to the stationary substrate 51 similarly to the case of the stationary substrate 51. Such an antireflection film can be formed by alternately stacking low refractive index films and high refractive index films, and is capable of decreasing the reflectance of the visible light on the surface of the movable substrate 52, and increasing the transmittance thereof.

The movable electrode 562 is opposed to the stationary electrode 561 via the gap G2, and is formed to have a ring-like shape, which is the same shape as that of the stationary electrode 561. The movable electrode 562 constitutes the electrostatic actuator 56 together with the stationary electrode 561. Further, the movable substrate 52 is provided with a movable extraction electrode 564 extending from the outer circumferential edge of the movable electrode 562 toward the vertex C1 of the movable substrate 52. The extending tip portion (a part located at the vertex C1 of the movable substrate 52) of the movable extraction electrode 564 forms a movable electrode pad 564P to be connected to the voltage control section 13.

The movable reflecting film 55 is disposed at the central portion of a movable surface 521A of the movable section 521 so as to be opposed to the stationary reflecting film 54 via the gap G1. As the movable reflecting film 55, a reflecting film having the same configuration as that of the stationary reflecting film 54 described above is used.

It should be noted that although the example in which the gap G2 is larger in dimension than the gap G1 is described in the present embodiment as described above, the invention is not limited to this example. In the case, for example, of using an infrared beam or afar infrared beam as the measurement target light, it is also possible to adopt a configuration in which the gap G1 is larger in dimension than the gap G2 depending on the wavelength band of the measurement target light.

The holding section 522 is a diaphragm surrounding the periphery of the movable section 521, and is formed to have a thickness dimension smaller than that of the movable section 521. Such a holding section 522 is easier to be deflected than the movable section 521, and it becomes possible to displace the movable section 521 toward the stationary substrate 51 with a weak electrostatic attractive force. On this occasion, since the movable section 521 has a larger thickness dimension and higher rigidity than those of the holding section 522, the shape variation of the movable section 521 does not occur even in the case in which the holding section 522 is pulled toward the stationary substrate 51 due to the electrostatic attractive force. Therefore, deflection of the movable reflecting film 55 provided to the movable section 521 does not occur, and it becomes possible to always keep the stationary reflecting film 54 and the movable reflecting film 55 in a parallel state.

It should be noted that although in the present embodiment, the holding section 522 having a diaphragm shape is shown as an example, the shape is not limited thereto, but there can also be adopted a configuration of, for example, providing beam-like holding sections arranged at regular angular intervals centered on the planar center point O.

As described above, the substrate peripheral section 525 is disposed outside the holding section 522 in the filter planar view. The surface of the substrate peripheral section 525 opposed to the stationary substrate 51 is provided with the second bonding section 523 opposed to the first bonding section 513. Further, the second bonding section 523 is provided with the second bonding film 532, and as described above, by bonding the second bonding film 532 to the first bonding film 531, the stationary substrate 51 and the movable substrate 52 are bonded to each other.

### Configurations of Detection Signal Processing Section, Voltage Control Section, and Light Receiving Control Section

Then, going back to FIG. 1, the optical module 10 will be explained.

The light receiving element 11 receives (detects) the light having been transmitted through the variable wavelength interference filter 5, and then outputs a detection signal based on the received light intensity to the detection signal processing section 12. Specifically, when the exposure to the light is performed, the light receiving element 11 outputs the detection signal corresponding to the light exposure.

Here, the light receiving element 11 accumulates the charge corresponding to the light exposure in each of the pixels. Then, the light receiving element 11 outputs the detection signal (voltage) while keeping the accumulated charge of each of the pixels corresponding to the light exposure. In other words, the light receiving element 11 is a nondestructive readout element configured so that the detection signal corresponding to the light exposure can be read out without resetting the accumulated charge.

The detection signal processing section 12 amplifies the detection signal (an analog signal) input, then converts the result into a digital signal, and then outputs the digital signal to the control section 20. The detection signal processing section 12 is constituted by an amplifier for amplifying the detection signal, an A/D converter for converting the analog signal into the digital signal, and so on.

The voltage control section 13 applies a drive voltage to the electrostatic actuator 56 of the variable wavelength interference filter 5 based on the control by the control section 20. Thus, the electrostatic attractive force is generated between the stationary electrode 561 and the movable electrode 562 of the electrostatic actuator 56, and the movable section 521 is displaced toward the stationary substrate 51.

The light receiving control section 14 controls the light receiving element 11 based on the instruction signal of the control section 20. Specifically, the light receiving control section 14 makes the light receiving element 11 start detection of the measurement light. Further, the light receiving control section 14 performs readout control for making the light receiving element 11 output the detection signal corresponding to a predetermined exposure time after the predetermined exposure time has elapsed. Further, the light receiving control section 14 performs reset control for removing the charge accumulated in each of the pixels of the light receiving element 11.

### Configuration of Control Section

Then the control section 20 of the spectroscopic measurement device 1 will be explained.

The control section 20 is configured by combining, for example, a CPU and a memory with each other, and controls an overall operation of the spectroscopic measurement device 1. As shown in FIG. 1, the control section 20 is provided with an exposure time setting section 21, a wavelength setting section 22, a detection signal acquisition section 23, a selection section 24, and a spectroscopic measurement section 25. Further, a memory of the control section 20 stores V-λ data representing a relationship between the wavelength of the light to be transmitted through the variable wavelength interference filter 5 and the drive voltage to be applied to the electrostatic actuator 56 corresponding to the wavelength.

The exposure time setting section 21 sets the exposure time of the measurement light by the light receiving element 11.

In the detailed description, in the invention, by making the exposure condition different between the wavelengths, there is obtained a plurality of (two in the present embodiment) detection signals different in light exposure from each other. Further, in the present embodiment, there are obtained the detection signals when making the exposure time as the exposure condition different between the wavelengths.

The exposure time setting section 21 sets a first exposure time and a second exposure time as the exposure times different from each other.

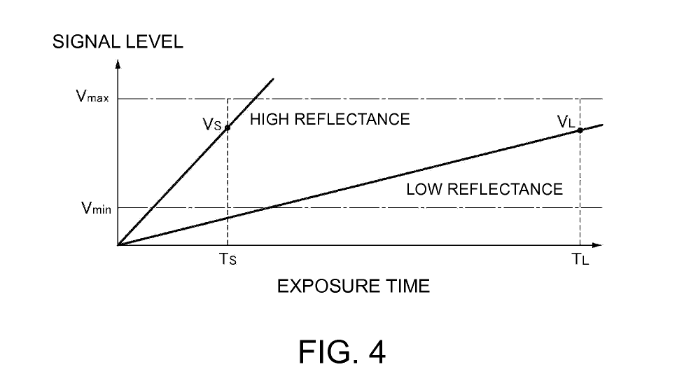

Here, the first exposure time and the second exposure time will be explained based on FIG. 4. FIG. 4 is a graph schematically showing a relationship between the exposure time by the light receiving element 11 and the detection signal (a pixel output; a voltage) by a single pixel. In FIG. 4, there is shown an example of measuring two measurement objects different in reflectance from each other, namely the case in which the reflectance of the measurement object is high, and the case in which the reflectance of the measurement object is low.

As shown in FIG. 4, in the case in which the reflectance of the measurement object is high, the rate of increasing the detection signal to the exposure time is high compared to the case in which the reflectance is low. Therefore, in the case in which the reflectance of the measurement object is high, it is possible to obtain the detection signal Vₛ corresponding to the light exposure in the correct exposure range, namely the detection signal not lower than a lower limit signal level Vₘᵢₙ corresponding to a lower limit value of the correct exposure range and lower than a maximum signal level Vₘₐₓ corresponding to an upper limit value of the correct exposure range, in a short exposure time (a first exposure time) Tₛ compared to the case in which the reflectance is low. On the contrary, if the exposure time is set longer with respect to the reflectance, there is a possibility that the light exposure exceeds the saturated light exposure, and in this case, the detection signal has the maximum signal level Vₘₐₓ for the light receiving element 11 to output, and it is not achievable to obtain the correct measurement data corresponding to the light exposure.

In contrast, in the case in which the reflectance of the measurement object is low, by performing the exposure for a long exposure time (a second exposure time) T_{L} compared to the case in which the reflectance is high, the detection signal V_{L} corresponding to the light exposure in the correct exposure range can be obtained. On the contrary, if the exposure time is set to be shorter, there is a possibility that the light exposure fails to reach the lower limit value of the optimum exposure, namely the detection signal fails to reach the lower limit signal level Vₘᵢₙ corresponding to the lower limit value of the optimum exposure described above, and in this case, the signal level of the detection signal is also low, and the noise component due to, for example, outside light is mixed significantly, and the SN ratio becomes worse.

The first exposure time and the second exposure time vary in accordance with the sensitivity of the light receiving element 11 and the illuminance of the outside light and the illumination light. In the present embodiment, it is assumed that the sensitivity of the light receiving element 11 is constant. Further, since the exposure times described above mainly depend on the illuminance of the outside light and the illumination light, the exposure time setting section 21 sets the exposure times based on a result of the spectroscopic measurement performed on a predetermined reference object (e.g., a white reference plate or a black reference plate) under the illumination environment in which the actual spectroscopic measurement is performed. It should be noted that it is also possible to store a table having the illuminance of the illumination light and the exposure times described above so as to correspond to each other in the memory in advance, and then set the exposure times based on the illuminance of the illumination light and the table.

The wavelength setting section 22 sets the target wavelength of the light to be taken out by the variable wavelength interference filter 5, and then outputs an instruction signal, which instructs to apply the drive voltage corresponding to the target wavelength thus set to the electrostatic actuator 56, to the voltage control section 13 based on the V-λ data.

The detection signal acquisition section 23 outputs an instruction signal for indicating the timing of starting the detection of the measurement light by the light receiving element 11 to the light receiving control section 14. Further, the detection signal acquisition section 23 obtains the detection signal in the light receiving element 11 at the timing when the first exposure time and the second exposure time set by the exposure time setting section 21 elapse. In other words, the detection signal acquisition section 23 obtains the detection signal corresponding to the light intensity of the light having the target wavelength having been transmitted through the variable wavelength interference filter 5 for each of the exposure times.

The selection section 24 selects one detection signal having a level lower than the maximum signal level Vₘₐₓ corresponding to the saturated light exposure of the light receiving element 11 and having a higher level than the other detection signal from the detection signals corresponding to each of the pixels of the light receiving element 11 obtained with respect to the exposure times in a pixel-by-pixel manner.

The spectroscopic measurement section 25 measures the spectrum characteristics of the measurement target light based on the light intensity obtained by the detection signal acquisition section 23.

### Exposure Time Setting Process

In the present embodiment, the spectroscopic measurement device 1 performs the exposure time setting process for setting the first exposure time and the second exposure time under the illumination environment in which the actual spectroscopic measurement process is performed before performing the spectroscopic measurement process.

In the exposure time setting process, the spectroscopic measurement is performed using a high-reflectance reference object having a reflectance not lower than a predetermined first specified value (e.g., 99%) with respect to each of the wavelengths in a predetermined wavelength band and a low-reflectance reference object having a reflectance not higher than a predetermined second specified value (e.g., 1%) with respect to each of the wavelengths in the wavelength band as the measurement objects. For example, in the case of performing the spectroscopic measurement on the visible light range, the white reference plate or the like can be used as the high-reflectance reference object, and the black reference plate or the like can be used as the low-reflectance reference object.

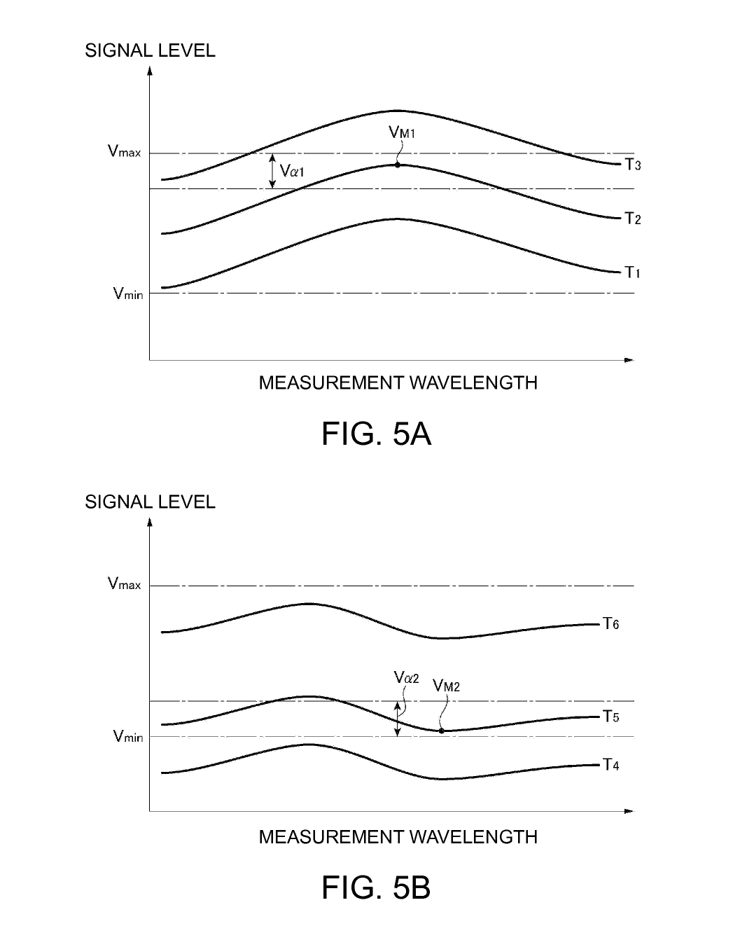

FIG. 5A is an example of the spectroscopic measurement result obtained when performing the spectroscopic measurement on the white reference plate as the measurement object, and FIG. 5B is an example of the spectroscopic measurement result obtained when performing the spectroscopic measurement on the black reference plate.

In FIG. 5A, in the case of varying the exposure time in a range of T1 through T3, the detection signal corresponding to each of the wavelengths is in a level lower than the maximum signal level Vₘₐₓ and in the case in which the exposure time exceeds T2 (e.g., the exposure time T3), the detection signal reaches the maximum signal level Vₘₐₓ in at least a part of the wavelength band.

The white reference plate has a high reflectance with respect to each of the wavelengths of the measurement object, and if the exposure time exceeds T2, the light exposure when receiving the light in the light receiving element 11 becomes equal to or higher than the saturated light exposure (becomes overexposure).

Therefore, the exposure time setting section 21 sets the first exposure time Tₛ so that the signal with the signal level not exceeding the maximum signal level Vₘₐₓ is output from the light receiving element 11 in the detection signal corresponding to each of the wavelengths.

Here, if the first exposure time Tₛ is set to be short within the selectable range, the signal value of the detection signal becomes small with respect to the reflected light of the white reference plate, and the signal level of the detection signal approaches the lower limit signal level Vₘᵢₙ side. Therefore, in the case of measuring the measurement object lower in reflectance than the white reference plate, underexposure occurs in many wavelengths, and there is a possibility that the light intensity measurement range, in which the detection is possible with a first detection signal obtained with the first exposure time Tₛ, becomes narrow. Therefore, it is preferable to set the exposure time, with which the detection signal having a level in a vicinity of the maximum signal level Vₘₐₓ is obtained in the detection signal corresponding to each of the wavelengths, as the first exposure time T_{S}. In other words, the exposure time setting section 21 sets the exposure time T2 as the first exposure time Tₛ in the example shown in FIG. 5A.

Specifically, the exposure time setting section 21 sets the first exposure time Tₛ so that the signal level V_{M1} of the detection signal with the highest signal level out of the detection signals in the wavelengths is lower than the maximum signal level Vₘₐₓ and is within a predetermined first threshold value Vα₁ from the maximum signal level Vₘₐₓ (Vₘₐₓ−Vα₁≦V_{M1}<Vₘₐₓ).

Further, in FIG. 5B, in the case of varying the exposure time in a range of T4 through T6, in the case in which the exposure time is shorter than T5 (e.g., the exposure time T4), the detection signal has a level lower than the lower limit signal level Vₘᵢₙ at least a part of the wavelength band. In contrast, in the exposure time range of T5 through T6, in the case in which the detection signal corresponding to each of the wavelengths has a level lower than the maximum signal level Vₘₐₓ and is equal to or higher than the lower limit signal level Vₘᵢₙ, and the exposure time exceeds T6, the level of the detection signal reaches the maximum signal level Vₘₐₓ in at least a part of the wavelength band.

The black reference plate has a low reflectance with respect to each of the wavelengths of the measurement object, and the light exposure in the case of receiving the light with the light receiving element 11 is lower than the lower limit value in at least a part of the measurement wavelength band in the case in which the exposure time is within T5.

Therefore, the exposure time setting section 21 sets the exposure time, with which the detection signal having the level equal to or higher than the lower limit level Vₘᵢₙ is obtained in the detection signal corresponding to each of the wavelengths, to the second exposure time T_{L}.

Here, if setting the second exposure time T_{L} to be long within the selectable range, the signal level of the detection signal increases to approach the maximum signal level Vₘₐₓ. Therefore, in the case of measuring the measurement object higher in reflectance than the black reference plate, overexposure occurs in many wavelengths, and there is a possibility that the light intensity measurement range, in which the detection is possible with a second detection signal obtained with the second exposure time T_{L}, becomes narrow. Therefore, it is preferable to set the exposure time, with which the detection signal having a level in a vicinity of the lower limit signal level Vₘᵢₙ is obtained in the detection signal corresponding to each of the wavelengths, as the second exposure time T_{L}. In other words, the exposure time setting section 21 sets the exposure time T5 as the second exposure time T_{L} in the example shown in FIG. 5B.

Specifically, the exposure time setting section 21 sets the second exposure time T_{L} so that the signal level V_{M2} of the detection signal with the lowest signal level out of the detection signals in the wavelengths is equal to or higher than the lower limit signal level Vₘᵢₙ, and is within a predetermined second threshold value Vα₂ from the lower limit signal level Vₘᵢₙ (Vₘᵢₙ≦V_{M2}≦Vₘᵢₙ+Vα₂).

### Spectroscopic Measurement Process

Then, the spectroscopic measurement process by such a spectroscopic measurement device 1 as described above will hereinafter be explained with reference to the drawings.

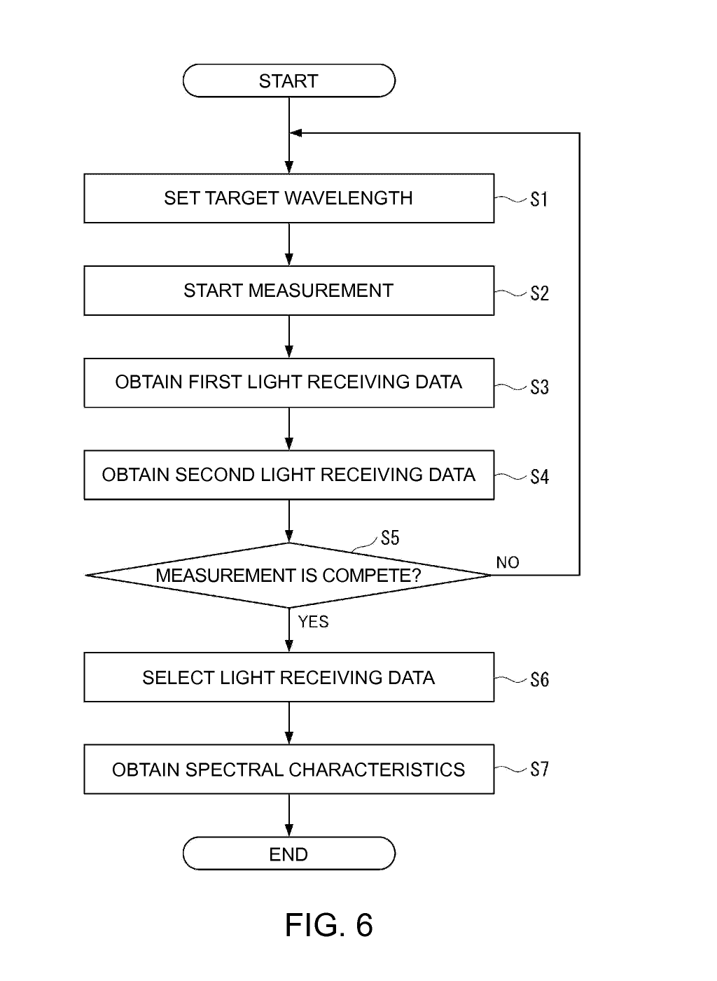

FIG. 6 is a flowchart of the spectroscopic measurement process performed by the spectroscopic measurement device 1.

In the spectroscopic measurement process, when receiving the instruction of starting the measurement, the wavelength setting section 22 reads out the drive voltage corresponding to the predetermined measurement wavelength in the measurement target wavelength band from the V-λ data stored in the memory, and then outputs an instruction signal of applying the drive voltage to the electrostatic actuator 56 to the voltage control section 13 as shown in FIG. 6. Thus, the drive voltage is applied to the electrostatic actuator 56, and the gap G1 is set to the dimension corresponding to the measurement wavelength (step S1).

When the gap G1 is set to the dimension corresponding to the measurement wavelength in the step S1, the light with the measurement wavelength is transmitted through the variable wavelength interference filter 5, and then enters the light receiving element 11. Here, the detection signal acquisition section 23 outputs an instruction signal of starting the detection of the measurement light to the light receiving control section 14. The light receiving control section 14 makes the light receiving element 11 start the detection of the measurement light based on the instruction signal (step S2).

When the first exposure time Tₛ has elapsed from when the spectroscopic measurement has been started, the detection signal acquisition section 23 outputs an instruction signal of instructing reading of the detection signal to the light receiving control section 14, and then obtains the detection signal (hereinafter also referred to as the first detection signal) in each of the pixels of the light receiving element 11. Then, the detection signal acquisition section 23 stores first light receiving data, which has the first detection signal of each of the pixels thus obtained, the pixel location (address data), and the wavelength (the measurement wavelength) of the light emitted from the variable wavelength interference filter 5 associated with each other, in the memory (step S3).

Subsequently, when the second exposure time T_{L} has elapsed from when the spectroscopic measurement has been started, the detection signal acquisition section 23 outputs an instruction signal of instructing reading of the detection signal to the light receiving control section 14, and then obtains the detection signal (hereinafter also referred to as the second detection signal) in each of the pixels of the light receiving element 11 similarly to the step S3. Then, the detection signal acquisition section 23 stores second light receiving data, which has the second detection signal of each of the pixels thus obtained, the pixel location (address data), and the measurement wavelength associated with each other, in the memory (step S4).

It should be noted that after the step S4, the light receiving control section 14 performs the reset control for removing the charge accumulated in each of the pixels of the light receiving element 11.

Subsequently, the control section 20 determines whether or not the light intensity of the light is obtained at all of the measurement wavelengths in the measurement target wavelength band (step S5).

If there is a measurement wavelength at which the spectroscopic measurement has not been performed in the step S5 (in the case in which the determination of “NO” has been made), the process returns to the step S1, and the light intensity measurement is continued with the measurement wavelength changed. As described above, by performing the measurement with the wavelength in the measurement target wavelength band switches sequentially as described above, the first light receiving data and the second light receiving data are obtained with respect to each of the wavelengths.

It should be noted that as the measurement wavelengths, it is possible to adopt wavelengths having previously been set by, for example, the measurer, or it is possible to adopt wavelengths arranged at predetermined wavelength intervals (e.g., intervals of 10 nm).

In the case in which it has been determined in the step S5 that the spectroscopic measurement at all of the measurement wavelengths has been performed, the selection section 24 selects either one of the first light receiving data and the second light receiving data as the measurement result with respect to each of the pixels at each of the wavelengths (step S6). The selection section 24 selects one light receiving data having a level lower than the maximum signal level Vₘₐₓ corresponding to the saturated light exposure and having a signal level higher than the other light receiving data out of the first detection signal and the second detection signal with respect to each of the pixels at each of the wavelengths.

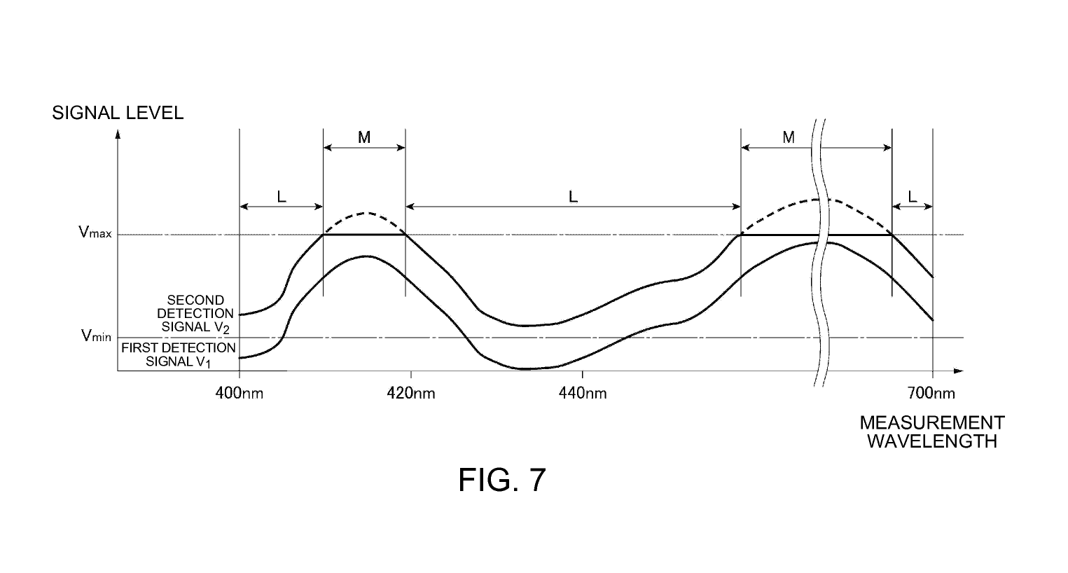

FIG. 7 is a graph showing an example of the relationship between the measurement wavelength and the signal level of the detection signal in a predetermined one pixel out of the plurality of pixels constituting the light receiving element 11. As shown in FIG. 7, the second detection signal V₂ becomes the detection signal corresponding to the second exposure time T_{L}, which is longer than the first exposure time Tₛ, and with which no underexposure occurs, and therefore has a signal level higher than that of the first detection signal V₁ and equal to or higher than the lower limit signal level Vₘᵢₙ. Further, the first detection signal V₁ becomes the detection signal corresponding to the first exposure tine Tₛ with which the light exposure does not exceed the saturated light exposure as described above, and therefore, has a signal level lower than the maximum signal level Vₘₐₓ with respect to each of the wavelengths in the measurement target wavelength band.

In the case in which the second detection signal V₂ is lower than the maximum signal level Vₘₐₓ namely in the wavelength bands in the sections L shown in FIG. 7, the second light receiving data corresponding to the second detection signal V₂ with the high light exposure is selected.

Further, in the case in which the second detection signal V₂ has reached the maximum signal level Vₘₐₓ namely in the wavelength bands in the sections M shown in FIG. 7, the first light receiving data corresponding to the first detection signal V₁ lower than the maximum signal level Vₘₐₓ is selected.

The selection section 24 performs the selection of the light receiving data in such a manner as described above with respect to each of the wavelengths and each of the pixels. Thus, the light receiving data obtained with the light exposure in the correct exposure range is selected with respect to each of the wavelengths and each of the pixels.

Then, the spectroscopic measurement section 25 obtains the dispersion spectrum using the light receiving data thus selected (step S7).

In the present embodiment, since the light exposure in the case in which the second detection signal is obtained in the sections L and the light exposure in the case in which the first detection signal V₁ is obtained in the sections M are different from each other, it is necessary to correct the detection signal. Here, the first light exposure in the case in which the first detection signal V₁ is obtained and the second light exposure in the case in which the second detection signal V₂ is obtained are obtained in the correct exposure range of the light receiving element 11, and these light exposures are proportional to the exposure time. Therefore, it is easy to convert the light exposure obtained in a different exposure time into the light exposure obtained in the same exposure time.

For example, the spectroscopic measurement section 25 multiplies the signal level of the first detection signal V₁ by a correction coefficient (e.g., (the second exposure time T_{L})/(the first exposure time Tₛ)) (see the signal level indicated by the dotted line in the sections M shown in FIG. 7). In contrast, the signal level of the second detection signal V₂ becomes the value corresponding to the light intensity without modification. Thus, it is possible to calculate the light intensity corresponding to the first detection signal in the sections M as the light intensity obtained in the case of performing the light intensity measurement in the second exposure time, which is the same as the exposure time in the sections L. It should be noted that it is also possible to perform a process of, for example, further multiplying a predetermined gain.

Then, the spectroscopic measurement section 25 calculates the dispersion spectrum of the measurement object using the light intensity calculated with respect to each of the wavelengths.

It should be noted that the spectroscopic measurement section 25 can also be configured so as to make the signal level of the second detection signal V₂ correspond to the signal level in the case of performing the light intensity measurement with the first exposure time by multiplying the signal level of the second detection signal V₂ by a correction coefficient (e.g., (the first exposure time Tₛ)/(the second exposure time T_{L})). Further, the spectroscopic measurement section 25 can also be configured so as to calculate the signal level corresponding to the light exposure per unit time by dividing the each of the detection signals by the corresponding exposure time.

### Functions and Advantages of First Embodiment

In the present embodiment, the detection signal acquisition section 23 obtains the first detection signal V₁ and the second detection signal V₂ corresponding respectively to the light exposures different from each other with respect to each of the wavelengths. Then, the selection section 24 selects the detection signal having a level, which is lower than the maximum signal level Vₘₐₓ and is the highest of the levels of the first detection signal V₁ and the second detection signal V₂, as the detection signal corresponding to the light exposure of each of the wavelengths with respect to each of the wavelengths.

According to this process, in the spectroscopic measurement device 1 and the spectroscopic measurement method of the present embodiment, it is possible to select the detection signal corresponding to the maximum light exposure not exceeding the saturated light exposure with respect to a plurality of wavelengths, and thus, suppression of overexposure and reduction of noise can be achieved.

Further, it is not necessary to perform the preliminary exposure for setting the correct exposure time for each of the wavelengths in each of the measurement objects in order to obtain the light exposure not exceeding the saturated light exposure and within the correct exposure range with respect to the plurality of wavelengths. Therefore, the measurement time can be shortened.

Further, since it is not necessary to perform the preliminary exposure, the measurement time can further be shortened in the case of continuously performing the measurement while changing the measurement object.

In the present embodiment, the exposure time setting section 21 sets the first exposure time for obtaining the first detection signal.

Specifically, as the first exposure time Tₛ, there is set the exposure time with which each of the detection signals corresponding respectively to the wavelengths does not exceed the maximum signal level Vₘₐₓ when obtaining the light exposure at each of the wavelengths with respect to the white reference object as a reference object high in reflectance in the measurement target wavelength band, namely the visible range in the present embodiment.

Thus, the first detection signal V₁ not exceeding the maximum signal level Vₘₐₓ corresponding to the saturated light exposure can be obtained with respect to each of the wavelengths. Therefore, even in the case of measuring the measurement object including the wavelength band area high in reflectance, the first detection signal V₁ corresponding to the light exposure with which no overexposure occurs with respect to each of the wavelengths in the measurement target wavelength band can be obtained without performing the preliminary exposure to set the exposure time.

In the present embodiment, the first exposure time as the exposure condition in the case of measuring the light reflected by the white reference plate is set to the exposure condition for setting the maximum value of the light exposure to be approximate to the saturated light exposure (lower than the saturated light exposure).

Thus, it is possible to set the signal level of the detection signal (the maximum value of the detection value), which corresponds to the maximum light intensity of the light to be made to be received by the light receiving element 11, to a value approximate to the maximum signal level Vₘₐₓ. Therefore, it is possible to increase the width of the detection value from the maximum value to the lower limit signal level Vₘᵢₙ in the first exposure time Tₛ described above, and thus, the range of the signal level, which can be detected by the light receiving element 11, can effectively be used.

Further, in the present embodiment, the exposure time setting section 21 sets the second exposure time T_{L} for obtaining the second detection signal V₂.

Specifically, as the second exposure time T_{L}, there is set the exposure time with which each of the detection signals corresponding respectively to the wavelengths becomes equal to or higher than the lower limit signal level when obtaining the light exposure at each of the wavelengths with respect to the black reference object as a reference object low in reflectance in the measurement target wavelength band, namely the visible range in the present embodiment.

Thus, there can be obtained the second detection signal V₂ having a level not lower than the lower limit signal level corresponding to the lower limit value of the correct exposure range with respect to each of the wavelengths.

By obtaining the first detection signal V₁ corresponding to the first exposure time Tₛ and the second detection signal V₂ corresponding to the second exposure time T_{L} as described above, even in the case of continuously measuring the measurement object high in reflectance or the measurement object low in reflectance, it is possible to obtain at least either of the first detection signal V₁ and the second detection signal V₂ as the detection signal corresponding to the correct exposure range. Therefore, the light exposure in the correct exposure range can be obtained without performing the preliminary exposure on each of the wavelengths to previously set the exposure time every time the measurement object is changed, and thus, the measurement time can be shortened while keeping the measurement accuracy.

In the present embodiment, the second exposure time T_{L} as the exposure condition in the case of measuring the light reflected by the black reference plate is set to the exposure condition for setting the minimum value of the light exposure to a value higher than the lower limit value of the correct exposure range.

Thus, it is possible to set the signal level of the detection signal (the minimum value of the detection value), which corresponds to the minimum light intensity of the light to be made to be received by the light receiving element 11, to a value approximate to the lower limit signal level Vₘᵢₙ. Therefore, it is possible to increase the width of the detection value from the minimum value to the maximum signal level Vₘₐₓ in the exposure condition described above, and thus, the range of the signal level, which can be detected by the light receiving element 11, can effectively be used.

In the present embodiment, the selection section 24 obtains the first detection signal V₁ and the second detection signal V₂ different from each other for each of the pixels of the light receiving element 11, and then selects one with the highest signal level not exceeding the maximum signal level Vₘₐₓ for each of the pixels.

Here, in the case of receiving the light with the light receiving element having a plurality of pixels, the signal level becomes high in the pixel corresponding to a region high in reflectance with respect to the measurement wavelength, and the signal level becomes low in the pixel corresponding to a region low in reflectance. In such a case, if the exposure time is set so that the light exposure corresponding to the region high in reflectance does not exceed the saturated light exposure in the case of setting the exposure time corresponding to each of the wavelengths using, for example, the preliminary exposure, it is not achievable to obtain a sufficient light exposure in the pixel corresponding to the region low in reflectance. Therefore, in the pixel corresponding to the region low in reflectance, the difference between the light exposure obtained and the noise component is small, and the content of the noise component in the detection signal becomes high to prevent execution of the spectroscopic measurement with high accuracy.

On the other hand, if the exposure time sufficient to obtain the light exposure in the region low in reflectance within the correct exposure range is set, there is a possibility that the overexposure occurs in the pixel corresponding to the region high in reflectance, and it is not achievable to perform the spectroscopic measurement with high accuracy.

In contrast, in the present embodiment, since the detection signal is selected pixel by pixel as described above, even in the pixel corresponding to the region low in reflectance, the measurement with the noise component reduced (high in S/N ratio) can be performed. Further, as described above, since the detection signal not exceeding the maximum signal level Vₘₐₓ is selected pixel by pixel, generation of the pixel, in which the correct received light intensity cannot be obtained due to overexposure, can be suppressed.

In the configuration described above, in the case of, for example, attempting to perform the spectroscopic measurement (color measurement) of a predetermined pixel designated by the user out of a taken image, the spectroscopic measurement with high accuracy can be performed pixel by pixel.

In the present embodiment, the detection signal acquisition section 23 obtains the detection signals corresponding to the respective light exposures with exposure times different from each other, namely the first exposure time Tₛ and the second exposure time T_{L} longer than the first exposure time Tₛ. In such a manner as described above, the light exposure can be made different due to the difference in exposure time. Therefore, it is not necessary to, for example, use a plurality of light receiving elements different in the area of the light receiving surface, and simplification of the configuration can be achieved.

In the present embodiment, the light receiving element 11 is configured so as to be able to sequentially read out the charges corresponding respectively to the light exposures in the exposure times different from each other using a nondestructive readout method.

In the spectroscopic measurement device 1 configured in such a manner, when performing the exposure with a plurality of exposure times, the light exposures corresponding respectively to the exposure times are sequentially read out in the plurality of exposure times within the maximum exposure time. Therefore, a plurality of light exposures can be obtained by a single measurement, and thus, the measurement time can be shortened.

In the present embodiment, as the spectroscopic element for emitting the light with a predetermined wavelength out of the reflected light of the measurement object X, there is used the variable wavelength interference filter 5 as the Fabry-Perot filter.

By using the variable wavelength interference filter 5 as the spectroscopic element, it is possible to measure the measurement target wavelength at fine intervals of, for example, 10 nm. Therefore, compared to the case in which the controllable intervals of the measurement target wavelength are long, the measurement can be performed on the measurement target wavelength band at a lot of measurement wavelengths (e.g., several tens of measurement wavelengths). In this case, if the preliminary exposure described above is performed on the measurement object at a plurality of measurement wavelengths, or the preliminary exposure is performed every time the measurement object is changed, the time consumed by the preliminary exposure is elongated compared to the case of performing the measurement at several wavelengths. Therefore, by adopting the variable wavelength interference filter 5 in the configuration in which it is not necessary to perform the preliminary exposure as in the present embodiment, further reduction of the measurement time can be achieved.

### Second Embodiment

A second embodiment of the invention will hereinafter be explained with reference to the accompanying drawings.

The spectroscopic measurement device according to the present embodiment is different from the first embodiment in the point that one pixel of the light receiving element is provided with a first light receiving section and a second light receiving section having respective light receiving areas, namely light receiving sensitivities, different from each other.

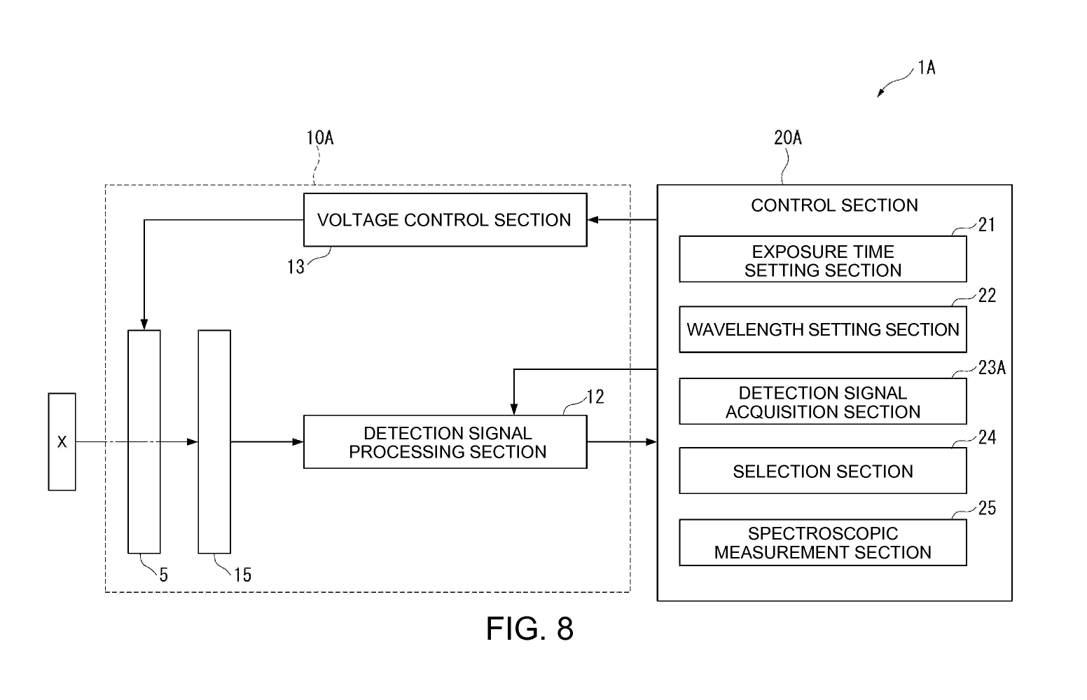

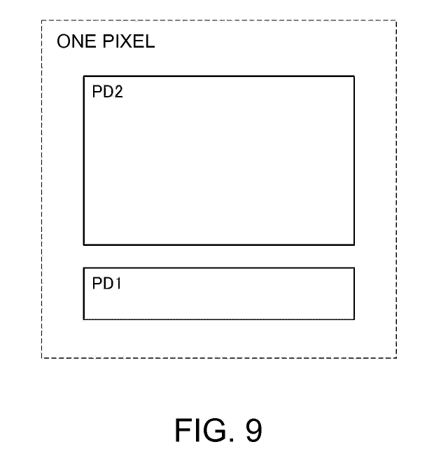

FIG. 8 is a block diagram showing a schematic configuration of a spectroscopic measurement device 1A according to the second embodiment of the invention. FIG. 9 is a diagram showing a schematic configuration of one pixel of the light receiving element according to the present embodiment.

It should be noted that in the following explanation, the constituents having already been explained are denoted with the same reference symbols, and the explanation thereof will be omitted or simplified.

### Configuration of Spectroscopic Measurement Device

As shown in FIG. 8, the spectroscopic measurement device 1A is provided with an optical module 10A, and a control section 20A.

The optical module 10A is provided with the variable wavelength interference filter 5, a light receiving element 15, the detection signal processing section 12, and the voltage control section 13.

The light receiving element 15 is provided with two photodiodes (PD) (PD1 and PD2 shown in FIG. 9) disposed in one pixel. These two photodiodes PD1 and PD2 have respective light receiving regions different in area, and the area of the light receiving region of PD2 is arranged to be larger than that of PD1. PD1 and PD2 each have the light receiving sensitivity corresponding to the area, and PD2 is higher in light receiving sensitivity than PD1. In such a light receiving element 15, in the case of performing the exposure for a predetermined exposure time, the detection signals corresponding respectively to the two light exposures different from each other corresponding respectively to PD1 and PD2 are output in each of the pixels.

The control section 20A is provided with the exposure time setting section 21, the wavelength setting section 22, a detection signal acquisition section 23A, the selection section 24, and the spectroscopic measurement section 25.

The detection signal acquisition section 23A obtains the detection signals corresponding respectively to PD1 and PD2 with respect to each of the pixels based on the detection signals output from the light receiving element 15 via the detection signal processing section 12. Further, the detection signal acquisition section 23A obtains the light receiving data, which has the detection signals of each of the pixels thus obtained, the pixel location (address data), and the measurement wavelength associated with each other, and then stores the light receiving data in the memory.

### Exposure Time Setting Process

Similarly to the first embodiment, also in the present embodiment, the spectroscopic measurement device 1A sets the exposure time under the illumination environment in which the actual spectroscopic measurement process is performed before performing the spectroscopic measurement process. Similarly to the first embodiment, in the method of setting the exposure time, setting of the exposure time can be performed based on the measurement result obtained by the spectroscopic measurement with respect to each of the measurement objects, namely the high-reflectance reference object (e.g., the white reference plate) and the low-reflectance reference object (e.g., the black reference plate).

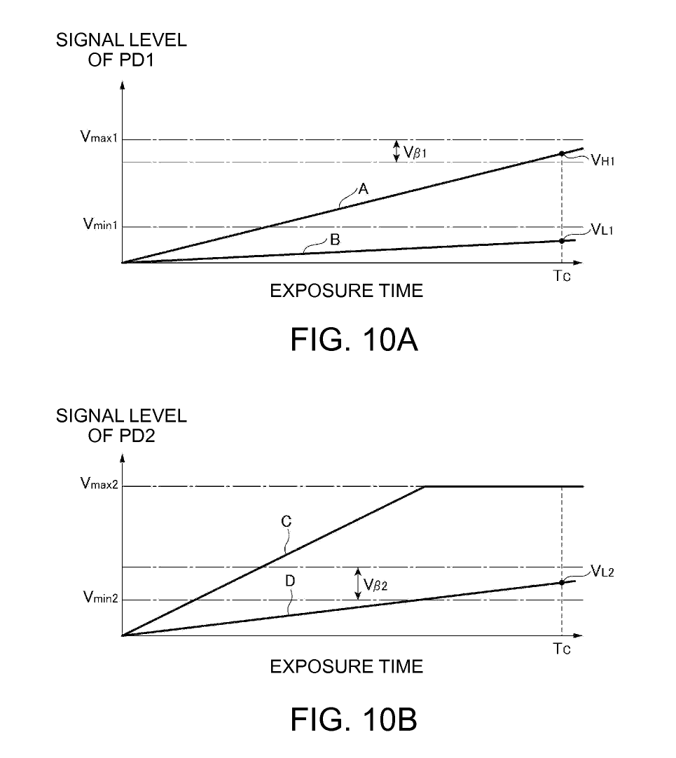

Here, FIG. 10A is a diagram showing an example of a relationship between the exposure time and the detection signal (a pixel output; a voltage) in PD1, and FIG. 10B is a diagram showing an example of a relationship between the exposure time and the detection signal (a pixel output; a voltage) in PD2. It should be noted that the detection signal A in FIG. 10A and the detection signal C in FIG. 10B are the measurement results when measuring the white reference plate, and the detection signal B in FIG. 10A and the detection signal D in FIG. 10B are the measurement results when measuring the black reference plate.

Specifically, as shown in FIG. 10A, the exposure time setting section 21 sets the exposure time T_{C} so that the signal level V_{H1} of the detection signal A (corresponding to the first detection signal in the first embodiment), which is output from PD1 in each of the wavelengths when measuring the reflected light from the white reference plate in PD1, becomes lower than the maximum signal level Vₘₐₓ₁ corresponding to the saturated light exposure of PD1, and becomes equal to or higher than the lower limit signal level Vₘᵢₙ₁ corresponding to the lower limit value of the correct exposure.

The signal level V_{L1} of the detection signal in the case of receiving the reflected light from the black reference plate with the exposure time T_{C} becomes lower than the signal level V_{H1}.

Further, as shown in FIG. 10B, the exposure time setting section 21 sets the exposure time T_{C} so that the signal level of the detection signal D (corresponding to the second detection signal in the first embodiment), which is output from PD2 with respect to each of the wavelengths when the exposure time T_{C} elapses while receiving the reflected light from the black reference plate in PD2, becomes lower than the maximum signal level Vₘₐₓ₂ corresponding to the saturated light exposure of PD2, and becomes equal to or higher than the lower limit signal level Vₘᵢₙ₂ corresponding to the lower limit value of the correct exposure.

In the case of measuring the reflected light from the white reference plate with the exposure time T_{C}, the signal level of the detection signal from PD2 has reached the maximum signal level Vₘₐₓ₂ of PD2.

In other words, in the present embodiment, the exposure time setting section 21 sets the exposure time T_{C} so that the level of the detection signal from PD1 does not exceed the maximum signal level Vₘₐₓ₁ in PD1 when measuring the white reference plate, and at the same time, the level of the detection signal from PD2 becomes equal to or higher than the lower limit signal level Vₘᵢₙ₂ when measuring the black reference plate.

It should be noted that the ratio between the light receiving sensitivities of PD1 and PD2 corresponds to the area ratio between the respective light receiving regions. Similarly to the preferable range of each of the exposure times in the first embodiment described above, it is preferable that the areas of PD1 and PD2 are previously set so that the signal levels, which are obtained in the case in which the white reference plate (the high-reflectance reference object) and the black reference plate (the low-reflectance reference object) are irradiated with the light with a reference light intensity having a specified light intensity for a predetermined time (e.g., the exposure time T_{C}), and then the reflected light is received by PD1 and PD2, fulfill each of the following conditions.

Specifically, the area (the area ratio to PD2) of PD1 is set so that the signal level V_{H1} of the detection signal A (corresponding to the first detection signal) with respect to each of the wavelengths in PD1 in the case of performing the exposure to the reflected light from the white reference plate with the exposure time T_{C} satisfies the following formula assuming that a predetermined level threshold is Vβ₁.

Vₘₐₓ₁−V_{β1}≦V_{H1}<Vₘₐₓ₁

Further, the area (the area ratio to PD1) of PD2 is set so that the signal level V_{L2} of the detection signal D (corresponding to the second detection signal) with respect to each of the wavelengths in PD2 in the case of performing the exposure to the reflected light from the black reference plate with the exposure time T_{C} satisfies the following formula assuming that a predetermined level threshold is Vβ₂.

Vₘᵢₙ₂≦V_{L2}≦Vₘᵢₙ₂≦V_{β2}

By setting the areas of (the area ratio between) the respective light receiving regions of PD1 and PD2 as described above, it is possible to inhibit the phenomenon that the light intensity measurement ranges which can be detected by the respective detection signals A, B becomes narrower from occurring, and thus, the light intensity measurement range of the light receiving element 15 can effectively be used similarly to the first embodiment.

### Spectroscopic Measurement Process

Then, the spectroscopic measurement process by the spectroscopic measurement device 1A will hereinafter be explained with reference to the drawing.

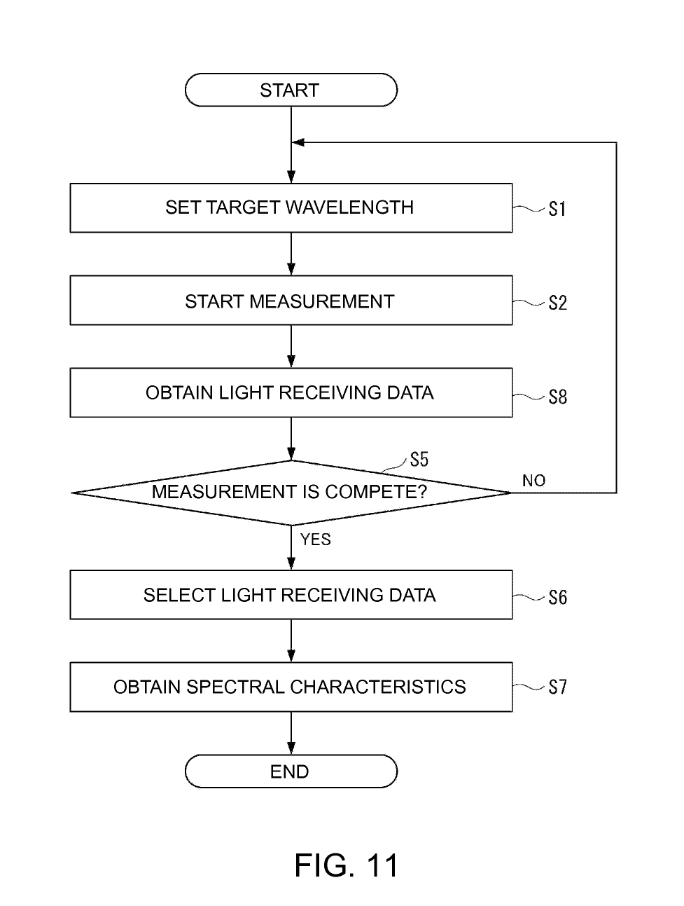

FIG. 11 is a flowchart of the spectroscopic measurement process performed by the spectroscopic measurement device 1A.

When receiving the instruction of the commencement of the measurement, the voltage control section 13 applies the drive voltage to the electrostatic actuator 56 based on the instruction signal from the wavelength setting section 22. Thus, the gap G1 is set to the dimension corresponding to the measurement wavelength (step S1).

Then, the detection signal acquisition section 23A obtains the first detection signal output from PD1 of each of the pixels of the light receiving element 11 and the second detection signal output from PD2 thereof. Acquisition of the detection signal from the light receiving element 11 is started, and detection of the measurement light is started (step S2).

The detection signal acquisition section 23A stores first light receiving data, which has the first detection signal of each of the pixels thus obtained, the pixel location, and the measurement wavelength associated with each other, in the memory. Further, the detection signal acquisition section 23A also stores second light receiving data, which has the pixel location, and the measurement wavelength associated with each other, in the memory similarly with respect to the second detection signal (step S8).

It should be noted that it is possible to obtain the light intensity in each of the pixel positions of each of the light receiving data and each of the measurement wavelengths based on (e.g., an integral value) each of the detection signals detected until the predetermined exposure time T_{C}, which has previously been set, elapses from the beginning of the detection. Further, the configuration of detecting the light intensity using the detection signal from the photodiode is described as an example in the present embodiment, but the element is not limited to the photodiode, and it is also possible to use a variety of types of light receiving elements capable of detecting the light intensity.

Subsequently, the control section 20A determines (step S5) whether or not the measured light intensity of the light is obtained at all of the measurement wavelengths in the measurement target wavelength band, and then returns to the step S1 if there remains the measurement wavelength at which the spectroscopic measurement has not yet been performed, and continues the light intensity measurement until the measurement at all of the measurement wavelengths is complete.

In the case in which it has been determined in the step S5 that the spectroscopic measurement at all of the measurement wavelengths has been performed, the selection section 24 selects either one of the first detection signal and the second detection signal as the measurement result with respect to each of the pixels at each of the wavelengths (step S6).

Then, the spectroscopic measurement section 25 obtains the dispersion spectrum using the light receiving data thus selected (step S7).

### Functions and Advantages of Second Embodiment

In the present embodiment, the light receiving element 15 is provided with PD1 and PD2 as the photodiodes different in sensitivity from each other disposed in each of the pixels. In other words, the light receiving element 15 has the two light receiving regions different in sensitivity from each other in each of the pixels.

According to this configuration, the spectroscopic measurement device receives the light with the light receiving element 15 having two light receiving regions different in sensitivity from each other in each of the pixels, and then obtains the light exposures (the first light exposure and the second light exposure) corresponding respectively to the light receiving regions. In other words, defining the exposure condition as the sensitivity of the light receiving element 15, the detection signals corresponding respectively to the light exposures different from each other are obtained. Thus, even in the case of making the light to be received with one exposure time, the two light exposures different from each other and corresponding respectively to the sensitivities of the light receiving regions can be obtained at the same time, and thus, the measurement time can be shortened.

### Modifications of Embodiments

It should be noted that the invention is not limited to each of the embodiments described above, but includes modifications and improvements within a range where the advantages of the invention can be achieved, and configurations, which can be obtained by, for example, arbitrarily combining the embodiments.

For example, although in each of the embodiments described above, there are described the examples of the spectroscopic measurement devices 1, 1A, the invention can be applied to an analysis device for performing componential analysis of the measurement object.

Further, although in each of the embodiments described above, there is described the configuration for obtaining the dispersion spectrum based on the measurement result as the spectroscopic measurement devices 1, 1A, the invention is not limited to this configuration, but can also be applied to a spectroscopic camera or the like for obtaining a spectral image. In other words, it is also possible to adopt a configuration in which the detection signal is selected with respect each of the pixels in each of the wavelengths, and the spectral image at each of the wavelengths is obtained based on the detection signal of each of the pixels thus selected. Further, it is also possible to perform a colorimetric process based on the spectral images thus obtained. Since the detection signal corresponding to the light exposure in the correct exposure range is selected for each of the pixels even in such a configuration, the spectral image with high accuracy can be obtained, and the color measurement with high accuracy can be performed.

Although in each of the embodiments described above, there is described the visible range as an example of the measurement target wavelength band, the invention is not limited to this example, and it is also possible to set an arbitrary wavelength band such as an infrared range as the measurement target wavelength band.

It should be noted that although in each of the embodiments described above, the white reference plate high in reflectance with respect to the visible range and the black reference plate low in reflectance are used in order to set the exposure time, in the case in which the wavelength band other than the visible range is included in the measurement target wavelength band, it is sufficient to use the high-reflectance reference high in reflectance with respect to the measurement target wavelength band and the low-reflectance reference low in reflectance with respect to the measurement target wavelength band.

Although in each of the embodiments described above, there is adopted the configuration in which the two different exposure conditions are used to each of the pixels at each of the wavelengths to obtain the detection signals corresponding respectively to the two different light exposures, the invention is not limited to this configuration.

For example, it is also possible to adopt a configuration in which three or more different exposure conditions are used to obtain the detection signals corresponding to three or more different light exposures. In other words, in the first embodiments, it is sufficient to obtain the light exposures with three or more different exposure times. Further, in the second embodiment, it is sufficient to adopt a configuration of disposing three or more light receiving regions having respective sensitivities different from each other. As described above, by obtaining the light exposures corresponding respectively to a larger number of exposure conditions, the dynamic range of measurable light intensity can be expanded. As a result, the spectroscopic measurement with high accuracy can more surely be performed on the measurement object having a high reflectance and the measurement object having a low reflectance without performing the preliminary exposure.

Although in the above description of the first embodiment, there is described the configuration of using the light receiving element configured so as to be able to perform nondestructive readout as an example, the invention is not limited to this example, and it is possible to use a light receiving element, the accumulated charge of which is reset every time the detection signal is read out. In this case, by performing the measurement with a plurality of exposure times with respect to each of the wavelengths, a plurality of light exposures is obtained with respect to each of the wavelengths.

Further, although in the above description of the second embodiment, the configuration in which the plurality of light receiving regions different in light receiving area is disposed, and a plurality of different light exposures is obtained by performing the exposure with the same exposure time is described as an example, the invention is not limited to this example. For example, it is also possible to adopt a configuration in which the light receiving sensitivity per unit area is made different between the light receiving regions to thereby make the sensitivities of the respective light receiving regions different from each other despite the light receiving areas are the same.

Further, it is also possible to combine the first and second embodiments with each other to arrange that the light receiving element has a plurality of light receiving regions, two or more different exposure times are set to each of the light receiving regions, and a plurality of detection signals corresponding respectively to the exposure times is obtained in each of the light receiving regions. In this case, for example, by obtaining the detection signals corresponding respectively to the two exposure times in each of the two light receiving regions, four different detection signals can be obtained.

In each of the embodiments described above, it is also possible to adopt a configuration in which, for example, the variable wavelength interference filter 5 is housed in a package, and the package is incorporated in the optical module 10. In this case, by sealing the package with vacuum, the drive response in the case of applying the voltage to the electrostatic actuator 56 of the variable wavelength interference filter 5 can be improved.

Although in each of the embodiments described above, there is adopted the configuration in which the variable wavelength interference filter 5 is provided with the electrostatic actuator 56 for varying the gap dimension between the reflecting films 54, 55 in accordance with the voltage applied, the invention is not limited to this configuration.

It is also possible to adopt a configuration of, for example, using a dielectric actuator having a first dielectric coil disposed instead of the stationary electrode 561, and having a second dielectric coil or a permanent magnet disposed instead of the movable electrode 562.

Further, it is also possible to adopt a configuration using a piezoelectric actuator instead of the electrostatic actuator 56. In this case, for example, a lower electrode layer, a piezoelectric film, and an upper electrode layer are disposed on the holding section 522 in a stacked manner, and the voltage applied between the lower electrode layer and the upper electrode layer is varied as an input value, and thus the piezoelectric film is expanded or contracted to thereby make it possible to deflect the holding section 522.

Although in the above description of each of the embodiments, the variable wavelength interference filter 5 having the stationary substrate 51 and the movable substrate 52 bonded in a state of being opposed to each other, the stationary reflecting film 54 disposed on the stationary substrate 51, and the movable reflecting film 55 disposed on the movable substrate 52 is described as an example of the Fabry-Perot etalon, the invention is not limited to this example.

It is also possible to adopt a configuration in which, for example, the stationary substrate 51 and the movable substrate 52 are not bonded to each other, and a gap varying section such as a piezoelectric element for varying the inter-reflecting film gap is disposed between these substrates.

Further, the invention is not limited to the configuration constituted by the two substrates. For example, it is also possible to use a variable wavelength interference filter having two reflecting films stacked on one substrate via a sacrifice layer, and provided with a gap formed by removing the sacrifice layer by etching or the like.

Further, it is also possible to use, for example, an acousto-optic tunable filter (AOTF) or a liquid crystal tunable filter (LCTF) as the spectroscopic element. It should be noted that it is preferable to use the Fabry-Perot filter as in each of the embodiments described above from a viewpoint of miniaturization of the device.

The entire disclosure of Japanese Patent Application No. 2013-223980 filed on Oct. 29, 2013 is expressly incorporated by reference herein.

What is claimed is:

1. A spectroscopic measurement device comprising:
a spectroscopic element capable of selectively emitting light with a predetermined wavelength out of incident light, and changing the wavelength of the light to be emitted;
a light receiving element adapted to output a detection signal corresponding to a light exposure in response to an exposure to the light emitted from the spectroscopic element;
a detection signal acquisition section adapted to obtain a plurality of detection signals different in the light exposure from each other with respect to each of the wavelengths; and
a selection section adapted to select the detection signal having a highest signal level out of signal levels of the detection signals obtained, which are lower than a maximum signal level corresponding to a saturated light exposure of the light receiving element.

2. The spectroscopic measurement device according to claim 1, wherein
the detection signal corresponding to a minimum light exposure out of the plurality of detection signals is obtained in an exposure condition in which when making the light reflected by a high-reflectance reference object having a reflectance higher than a first specified value with respect to light with each of wavelengths in a predetermined wavelength band enter the spectroscopic element, and then receiving the light with the light receiving element while sequentially changing the wavelength with the spectroscopic element, the detection signal corresponding to each of the wavelengths has a signal level lower than the maximum signal level.

3. The spectroscopic measurement device according to claim 2, wherein
the detection signal corresponding to the minimum light exposure out of the plurality of detection signals is obtained in an exposure condition in which when making the light reflected by the high-reflectance reference object enter the spectroscopic element, and then receiving the light with the light receiving element while sequentially changing the wavelength with the spectroscopic element, a maximum value of the detection signal corresponding to each of the wavelengths is lower than the maximum signal level, and is within a first threshold value from the maximum signal level.

4. The spectroscopic measurement device according to claim 2, wherein
the detection signal corresponding to a maximum light exposure out of the plurality of detection signals is obtained in an exposure condition in which when making the light reflected by a low-reflectance reference object having a reflectance lower than a second specified value smaller than the first specified value with respect to light with each of the wavelengths in the predetermined wavelength band enter the spectroscopic element, and then receiving the light with the light receiving element while sequentially changing the wavelength with the spectroscopic element, a signal level of the detection level is one of equal to and higher than a lower limit signal level corresponding to a lower limit value of the light exposure of correct exposure.

5. The spectroscopic measurement device according to claim 4, wherein
the detection signal corresponding to the maximum light exposure out of the plurality of detection signals is obtained in an exposure condition in which when making the light reflected by the low-reflectance reference object enter the spectroscopic element, and then receiving the light with the light receiving element while sequentially changing the wavelength with the spectroscopic element, a minimum value of the detection signal corresponding to each of the wavelengths is higher than the lower limit signal level, and is within a second threshold value from the lower limit signal level.

6. The spectroscopic measurement device according to claim 1, wherein
the light receiving element has a plurality of pixels adapted to receive light, and
the selection section selects the detection signal with respect to each of the pixels.

7. The spectroscopic measurement device according to claim 1, wherein
the detection signal acquisition section controls an exposure time of the light receiving element to obtain a plurality of detection signals different in light exposure.

8. The spectroscopic measurement device according to claim 7, wherein
the light receiving element sequentially reads out a charge obtained by the exposure with an exposure time shorter than a maximum exposure time for maximizing the light exposure using a nondestructive readout method not accompanied by reset of the accumulated charge.

9. The spectroscopic measurement device according to claim 1, wherein
the light receiving element has a plurality of light receiving regions different in sensitivity from each other.

10. The spectroscopic measurement device according to claim 1, wherein
the spectroscopic element is a Fabry-Perot filter.

11. A spectroscopic measurement method in a spectroscopic measurement device including
a spectroscopic element capable of selectively emitting light with a predetermined wavelength out of incident light, and changing the wavelength of the light to be emitted,
a light receiving element adapted to output a detection signal corresponding to a light exposure in response to an exposure to the light emitted from the spectroscopic element, and
a processing section adapted to obtain and then process the detection signal, the method comprising:
obtaining a plurality of detection signals different in the light exposure from each other with respect to each of the wavelengths; and
selecting the detection signal having a highest signal level out of signal levels of the detection signals obtained, which are lower than a maximum signal level corresponding to a saturated light exposure of the light receiving element.
